(19) United States
(12) Patent Application Publication
(10) Pub. No.: US 2022/0039044 A1
(43) Pub. Date: Feb. 3, 2022

(54) USER EQUIPMENT, BASE STATION AND METHOD FOR COMMUNICATION IN NON-TERRESTRIAL NETWORK

(71) Applicant: LENOVO (BEIJING) LIMITED, Beijing (CN)

(72) Inventors: Lianhai Wu, Beijing (CN); Haiming Wang, Beijing (CN); Jing Han, Beijing (CN); Jie Shi, Beijing (CN); Jie Hu, Beijing (CN)

(21) Appl. No.: 17/279,905

(22) PCT Filed: Dec. 18, 2018
(86) PCT No.: PCT/CN2018/121842

§ 371 Date: Mar. 25, 2021

(51) Int. Cl. H04W 56/00; H04B 7/185; H04W 36/08; H04W 74/00; H04W 36/00

(52) U.S. Cl. CPC H04W 56/0045; H04B 7/1851; H04W 36/0055; H04W 74/006; H04W 36/08

(57) ABSTRACT

The present application relates to a user equipment, a base station and method for communication in non-terrestrial network. The base station broadcasts a system information which includes a parameter related with a non-terrestrial network. The user equipment receives the system information and determines whether the base station is a non-terrestrial base station based on the parameter. Further, for initializing handover procedure, the base station generates a timer and transmits a message of handover command with the timer to the user equipment. The user equipment receives the message and handovers from the base station to another base station when the timer expires.

### TECHNICAL FIELD

The present disclosure generally relates to user equipment, a base station and a communication method thereof, and especially to user equipment, a base station and a method for communication in non-terrestrial network.

### BACKGROUND OF THE INVENTION

5G is the fifth generation of cellular mobile communications, representing the next stage of cellular communications after the 4G (LTE/WiMax), 3G (UMTS) and 2G (GSM) systems. In the network architecture of 5G, high data rate, reduced latency, energy saving, cost reduction, higher system capacity, and widespread device connectivity are required.

Under normal circumstances, the use of terrestrial systems for 5G network is sufficient. In some situations, though, non-terrestrial systems may be necessary to meet requirements of a 5G network. However, due to significant transmission delays in non-terrestrial systems, protocols and communication methods used in terrestrial systems may not be directly applicable to non-terrestrial systems.

### BRIEF SUMMARY OF THE INVENTION

One embodiment of the present disclosure provides a method of a user equipment. The method includes: receiving, by the user equipment, a system information from a base station for random access, wherein the system information includes a parameter; and determining, by the user equipment, whether the base station is a non-terrestrial base station or a terrestrial base station based on the parameter included in the system information.

Another embodiment of the present disclosure provides a method of a base station. The method includes: broadcasting, by the base station, a system information which includes a parameter related with a non-terrestrial network to the user equipment.

Yet another embodiment of the present disclosure provides a method of a user equipment. The method includes: receiving, by the user equipment, a message of handover command including a timer from a base station; and handovering, by the user equipment, from the base station to another base station based on the message when the timer expires.

Yet another embodiment of the present disclosure provides a method of a base station. The method includes: transmitting, by base station, a message of handover command including a timer to a user equipment so that the user equipment can handover from the base station to another base station based on the handover message when the timer expires.

Yet another embodiment of the present disclosure provides a user equipment. The user equipment includes a transceiver and a processor. The transceiver and the processor are electrically coupled. The transceiver is configured to receive a system information from a base station for random access, wherein the system information includes a parameter. The processor is configured to: determine whether the base station is a non-terrestrial base station or a terrestrial base station based on the parameter.

Yet another embodiment of the present disclosure provides a base station. The base station includes a transceiver and a processor. The transceiver and the processor are electrically coupled. The processor is configured to: broadcast a system information which includes a parameter related with a non-terrestrial network to the user equipment by the transceiver.

Yet another embodiment of the present disclosure provides a user equipment. The user equipment includes a transceiver and a processor. The transceiver and the processor are electrically coupled. The transceiver is configured to receive a message of handover command including a timer from a base station. The processor is configured to handover from the non-terrestrial base station to another base station based on the message when the timer expires.

Yet another embodiment of the present disclosure provides a base station. The base station includes a transceiver. The transceiver is configured to transmit a message of handover command including a timer to a user equipment so that the user equipment can handover from the base station to another base station based on the message when the timer expires.

### BRIEF DESCRIPTION OF THE DRAWINGS

FIG. 1A is a schematic view of a network system according to an embodiment of the present disclosure.

FIG. 1B is a block diagram of the base station according to an embodiment of the present disclosure.

FIG. 1C is a block diagram of the user equipment according to an embodiment of the present disclosure.

FIG. 1D is a schematic view of how random access is performed base on a first offset according to an embodiment of the present disclosure.

FIG. 1E is a schematic view of how random access is performed base on a second offset according to an embodiment of the present disclosure.

FIG. 1F is a schematic view of the window size of the time slots according to an embodiment of the present disclosure.

FIG. 2A is a schematic view of a network system according to an embodiment of the present disclosure.

FIG. 2B is a block diagram of the base station according to an embodiment of the present disclosure.

FIG. 2C is a block diagram of the user equipment according to an embodiment of the present disclosure.

FIGS. 3A to 3B are flowchart diagrams according to an embodiment of the present disclosure.

FIG. 4 is a flowchart diagram according to an embodiment of the present disclosure.

FIG. 5 is a flowchart diagram according to an embodiment of the present disclosure.

FIG. 6 is a flowchart diagram according to an embodiment of the present disclosure.

FIG. 7 is a flowchart diagram according to an embodiment of the present disclosure.

FIG. 8 is a flowchart diagram according to an embodiment of the present disclosure.

FIG. 9 is a flowchart diagram according to an embodiment of the present disclosure.

FIG. 10 is a flowchart diagram according to an embodiment of the present disclosure.

FIG. 11 is a flowchart diagram according to an embodiment of the present disclosure.

FIG. 12 is a flowchart diagram according to an embodiment of the present disclosure.

FIG. 13 is a flowchart diagram according to an embodiment of the present disclosure.

### DETAILED DESCRIPTION OF THE INVENTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

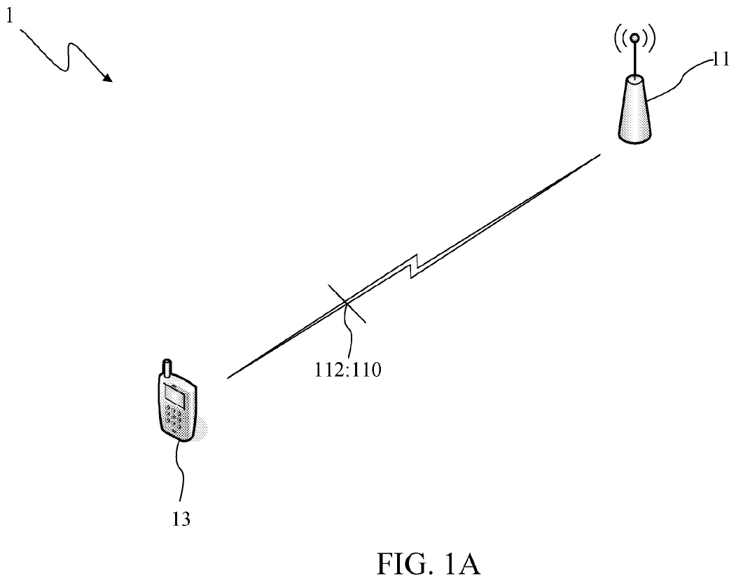

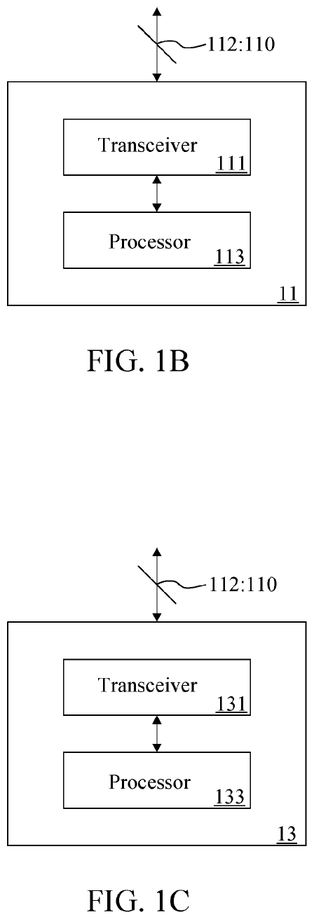

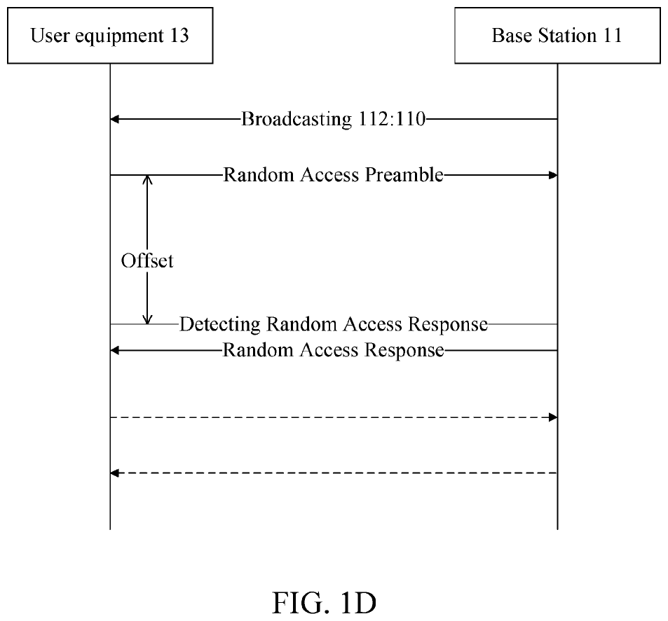

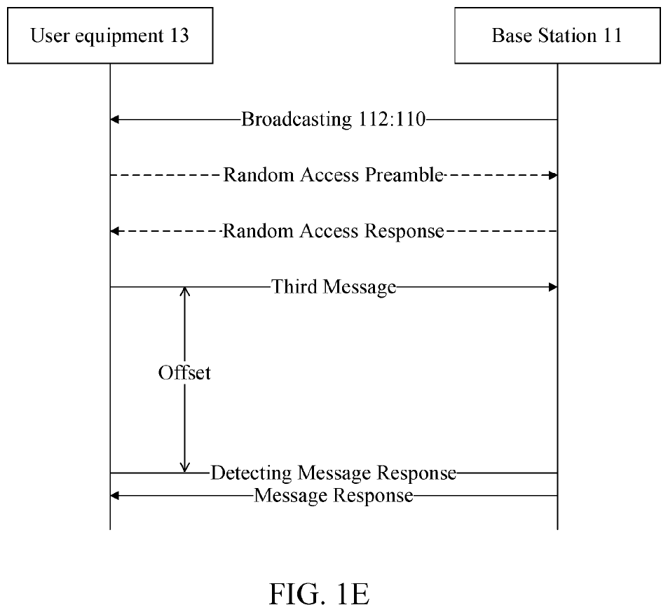

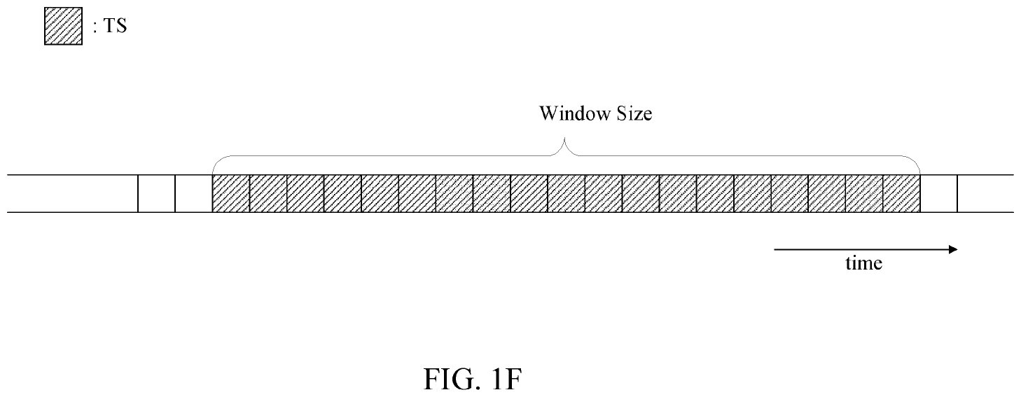

Please refer to FIG. 1A to FIG. 1C. FIG. 1A is a schematic view of a network system 1 according to an embodiment of the present disclosure. The network system 1 includes a base station 11 and a user equipment 13. FIG. 1B is a block diagram of the base station 11 according to the embodiment of the present disclosure. The base station 11 includes a transceiver 111 and a processor 113. The transceiver 111 and the processor 113 are electrically coupled (e.g., electrically connected via bus). FIG. 1C is a block diagram of the user equipment 13 according to the embodiment of the present disclosure. The user equipment 13 includes a transceiver 131 and a processor 133. The transceiver 131 and the processor 133 are electrically coupled (e.g., electrically connected via a bus). The interactions between the individual elements will be further described hereinafter.

Before establishing a connection between the base station 11 and the user equipment 13, a mechanism may be introduced to allow the user equipment 13 to identify the type of network cell provided by the base station 11. In some embodiments, the base station 11 is a non-terrestrial base station. Therefore, the processor 113 of the base station 11 generates a parameter 110 for the user equipment 13 to determine that the base station 11 is a non-terrestrial base station. The processor 113 of the base station 11 embeds the parameter 110 in a system information 112. The transceiver 111 of the base station 11 broadcasts the system information 112 which includes the parameter 110.

Before establishing a connection with the base station 11, the transceiver 131 of the user equipment 13 receives the system information 112 which includes the parameter 110. Accordingly, the processor 133 of the user equipment 13 determines whether the base station 13 is a non-terrestrial base station or a terrestrial base station based on the parameter 110. In detail, the processor 133 of the user equipment 13 determines that the base station 11 is a non-terrestrial base station when the parameter 110 is included in the system information 112. Similarly, in some embodiments, the processor 133 of the user equipment 13 determines that a base station is a terrestrial base station when a system information from this base station is without a parameter of the present disclosure.

In some embodiments, the parameter 110 may be a first offset, and the first offset may be configured for a random access procedure. Please refer to FIG. 1D, which is a schematic view of how random access is performed base on the first offset. In detail, the first offset included in the system information 112 is configured to allow the user equipment 13 to start to detect a random access response from the base station 11 after waiting for a period time based on the first offset. The period starts after a random access preamble is transmitted to the base station 11. In other words, based on obtaining the first offset of the system information 112, the user equipment 13 performs the operations of: (1) transmitting the random access preamble to the base station 11; (2) waiting for the period of time based on the first offset after the random access preamble is transmitted; and (3) detecting the random access response from the base station 11 after waiting for the period of time based on the first offset.

In some embodiments, the parameter 110 may be a second offset, and the second offset is configured for a random access procedure as well. Please refer to FIG. 1E, which is a schematic view of how random access is performed base on the second offset. In detail, the second offset included in the system information 112 is configured to allow the user equipment 13 to starts to receive a message response (e.g., a contention resolution response as fourth message in random access procedure) from the base station 11 after waiting for a period of time of the second offset. The period starts after a third message of random access procedure (e.g., scheduled uplink transmission message as a third message in random access procedure) is transmitted to the base station 11. In other words, based on obtaining the second offset, the user equipment 13 performs, at the middle of random access procedure, the operations of: (1) transmitting the third message to the base station 11; (2) waiting the period of the time based on the second offset after the third message is transmitted; and (3) receiving the response from the base station 11 after waiting for the time of the second offset.

In some embodiments, the parameter 110 may be a parameter of a window size, which is greater than a threshold, for receiving a random access response from the base station 11. Please refer to FIG. 1F, which is a schematic view of the window size of the time slots. It should be noted that, in traditional random access procedure, maximum of window size for receiving a random access response is about 180 slots (i.e., less than 10 milliseconds). For a non-terrestrial network, a window size of time slots IS for receiving a random access response may be configured to be extended due to transmission delay (e.g., Max Round Trip Delay for non-terrestrial network may be more than 200 milliseconds). Accordingly, when the parameter of the window size for receiving the random access response is configured to be greater than the threshold (e.g., greater than 100 milliseconds), the processor 133 of the user equipment 13 may determine that the parameter of the window size is configured for non-terrestrial network, and may determine that the base station 11 is a non-terrestrial base station after the transceiver 131 receives the parameter of the window size.

In some embodiments, the parameter 110 may be a time advance parameter which is configured for a non-terrestrial network. It should be note that, in traditional random access procedure, time advance parameter is selected from specific time variables (e.g., time variable of TimingAdvanceOffset selected from {n0, n25560, n39936}). For non-terrestrial network, the time advance parameter may be redesigned due to transmission delay. Accordingly, when the redesigned time advance parameter is configured for a non-terrestrial network, the processor 133 of the user equipment 13 may determine that the base station 11 is a non-terrestrial base station after the transceiver 131 receives the redesigned time advance parameter.

In some embodiments, the parameter 110 may be directly configured for non-terrestrial network, and the parameter 110 may be included in a system information block of the system information 112. Accordingly, when the system information block is configured for non-terrestrial network, the processor 133 of the user equipment 13 may determine that the base station 11 is a non-terrestrial base station after the transceiver 131 receiving the system information block including the parameter 110.

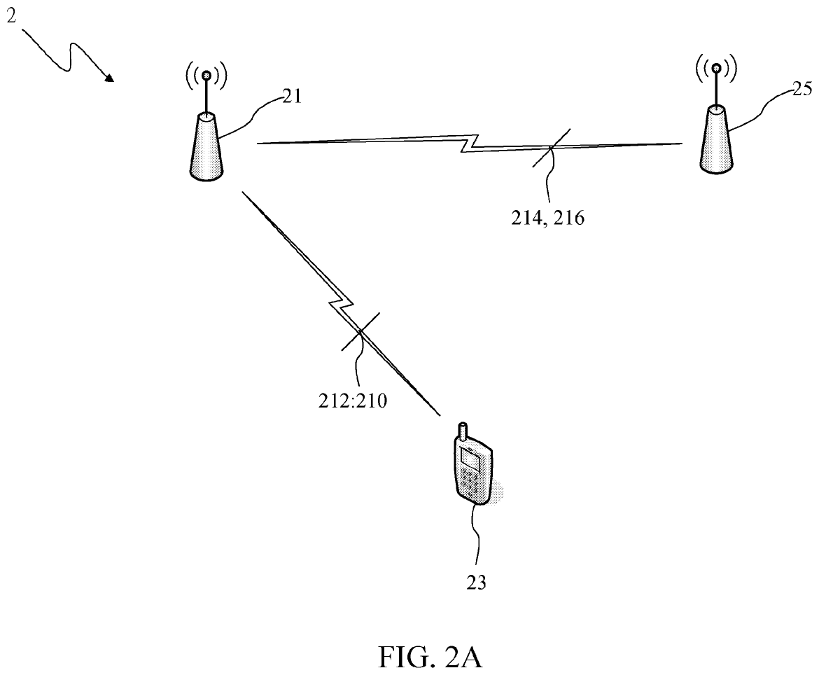

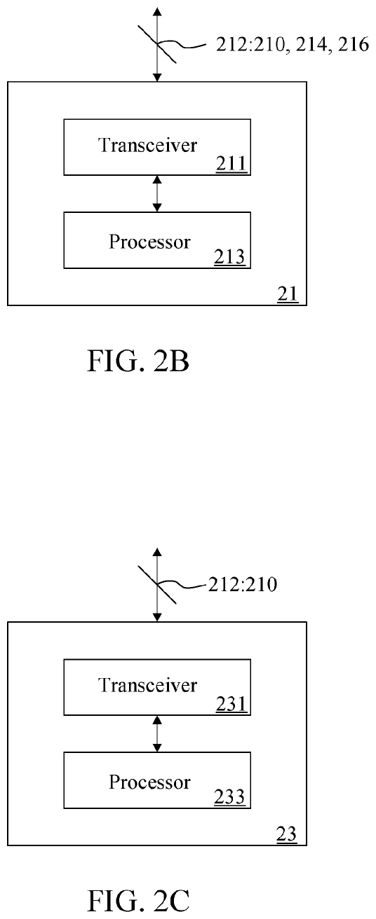

Please refer to FIG. 2A to FIG. 2C. FIG. 2A is a schematic view of a network system 2 according to an embodiment of the present disclosure. The network system 2 includes a base station 21 and a user equipment 23, and the base station 21 and the user equipment 23 are under radio resource connection connected status. FIG. 2B is a block diagram of the base station 21 according to the embodiment of the present disclosure. The base station 21 includes a transceiver 211 and a processor 213. The transceiver 211 and the processor 213 are electrically coupled (e.g., electrically connected via bus). FIG. 2C is a block diagram of the user equipment 13 according to the embodiment of the present disclosure. The user equipment 23 includes a transceiver 231 and a processor 233. The transceiver 231 and the processor 233 are electrically coupled (e.g., electrically connected via bus). The interactions between the individual elements will be further described hereinafter.

In some embodiments, the base station 21 is a non-terrestrial base station. Therefore, the user equipment 23 may leave the signal coverage of the base station 21 since the base station 21 may move. Accordingly, the base station 21 may determine whether the user equipment 23 performs a handover procedure from the base station 21 to another base station 25, which is a non-terrestrial base station as well, or not. In detail, the processor 213 of the base station 21 generates a timer 210 based on base station mobility information of the base station 21 and the base station 25. Next, when the base station 21 determines that the user equipment 23 is going to leave the signal coverage of the base station 21, the processor 213 of the base station 21 initializes handover procedure for the user equipment 23 and the transceiver 211 of the base station 21 transmits a message 212 of handover command, which includes the timer 210, to the user equipment 23.

After the transceiver 231 of the user equipment 23 receives the message 212 of handover command, the processor 233 of the user equipment 23 performs handover from the base station 21 to the base station 25 based on the message 212 when the timer 210 expires. Particularly, after the transceiver 231 of the user equipment 23 receives the message 212 of handover command, the timer 210 is triggered. Subsequently, when the timer 210 expires, the processor 233 of the user equipment 23 performs handover from the base station 21 to the base station 25 based on the message 212. Accordingly, the handover procedure of the present disclosure may be directly initialized by the timer 210 from the base station 21 so that the user equipment 23 may not need to perform operations of measuring and reporting of traditional handover. Therefore, the user equipment 23 may achieve the target of power saving.

In some embodiments, before performing handover from the base station 21 to the base station 25, the processor 233 of the user equipment 23 calculates an average speed of the user equipment 23 before the timer 210 expires. In other words, within an active period of the timer 210, the speeds of the user equipment 23 are used for calculating the average speed of the user equipment 23. If the average speed is less than a first threshold, the handover is triggered after the timer 210 expires. However, if the average speed is not less than the first threshold, the handover is not triggered.

In some embodiments, before performing handover from the base station 21 to the base station 25, the processor 233 of the user equipment 23 calculates a moving distance of the user equipment 23 before the timer 210 expires. In other words, within an active period of the timer 210, the locations of the user equipment 23 are used for calculating the moving distance of the user equipment 23. If the moving distance is less than a second threshold, the handover is triggered after the timer 210 expires. However, if the moving distance is not less than the second threshold, the handover is not triggered.

In some embodiments, the base station 21 and the base station 25 are disposed on different satellites, and the base station mobility information of the base station 21 and the base station 25 may be satellite ephemeris data. Accordingly, since the satellite ephemeris data includes information for calculating position of each satellite in orbit, the processor 213 of the base station 21 may calculate the timer 210 based on the satellite ephemeris data. In particular, because the base station 21 and the base station 25 are disposed on different satellites, the base station 21 and the base station 25 may move regularly based on the satellite ephemeris data. Therefore, while the user equipment 23 is substantially static, the base station 21 may calculate: (1) the timing of when the user equipment 23 leaves the signal coverage of the base station 21; and (2) the timing of when the user equipment 23 enters the signal coverage of the base station 25. Hence, the processor 213 of the base station 21 may calculate the timer 210 based on the timings for the user equipment 23 to trigger handover procedure from the base station 21 to the base station 25.

In some embodiments, while establishing an Xn interface with the base station 25, the transceiver 211 of the base station 21 transmits an Xn interface setup message 214 to the base station 25 for indicating a cell type of the base station 21. In some embodiments, the cell type may include a geostationary type (i.e., GEO-cell type) or a low earth orbit type (i.e., LEO-cell type). It should be noted that the Xn interface between the base station 21 and the base station 25 may be an interface for the interconnection of two Next-Generation Radio Access Network (NG-RAN) nodes within the NG-RAN architecture.

In some embodiments, the transceiver 211 of the base station 21 transmits a handover request 216 to the base station 25. The handover request 216 includes information of the user equipment 23 and an indication for notifying a later conditional handover performed by the user equipment 23. Accordingly, the base station 25 is capable of storing the information of the user equipment 23 and is capable of determining a period for waiting for the conditional handover. If the period is elapsed but the user equipment 23 does not perform the handover, the base station 25 releases resources related to the information of the user equipment 23.

It shall be particularly appreciated that the network systems described above may be non-terrestrial networks, the non-terrestrial base station mentioned in the above embodiments may be disposed on a satellite, a regular aircraft or an unmanned aircraft system, and the base station mobility information may be satellite ephemeris data or flying schedules of the aircrafts. The processors mentioned in the above embodiments may be a central processing unit (CPU), other hardware circuit elements capable of executing relevant instructions, or combination of computing circuits that are well-known by those skilled in the art based on the above disclosures. Moreover, the transceivers mentioned in the above embodiments may be a combination of a network data transmitter and a network data receiver. However, such description is not intended to limit the hardware implementation embodiments of the present disclosure.

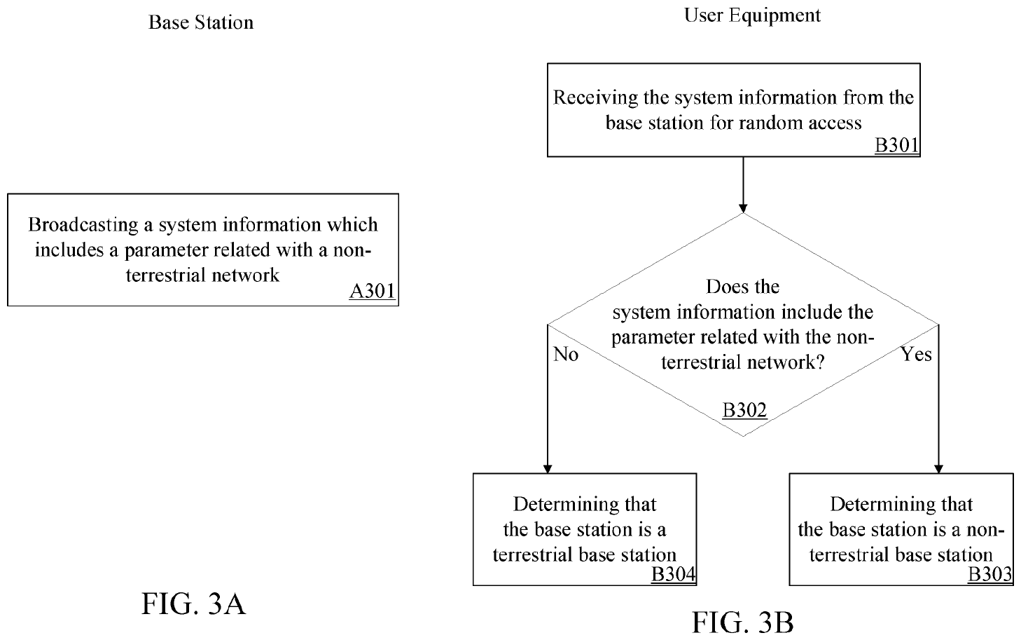

Some embodiments of the present disclosure include a method, and flowchart diagrams thereof are shown in FIGS. 3A to 3B. The method of some embodiments is for use in a network system (e.g., the network system of the aforesaid embodiments), and the network system includes a user equipment and a base station (e.g., the user equipment and the base station of the aforesaid embodiments). Detailed operations of the method are as follows.

Please refer to FIG. 3A first. Operation A301 is executed to broadcast, by the base station, a system information which includes a parameter related with a non-terrestrial network. Next, please refer to FIG. 3B. Operation B301 is executed to receive, by the user equipment, the system information from the base station for random access. Operation B302 is executed to determine, by the user equipment, whether the base station is a non-terrestrial base station or a terrestrial base station based on the system information. If the parameter is included in the system information, operation B303 is executed to determine, by the user equipment, that the base station is a non-terrestrial base station. In some embodiments, if the user equipment receives a system information which is without the parameter, operation SB304 is executed to determine, by the user equipment, that the base station is a terrestrial base station.

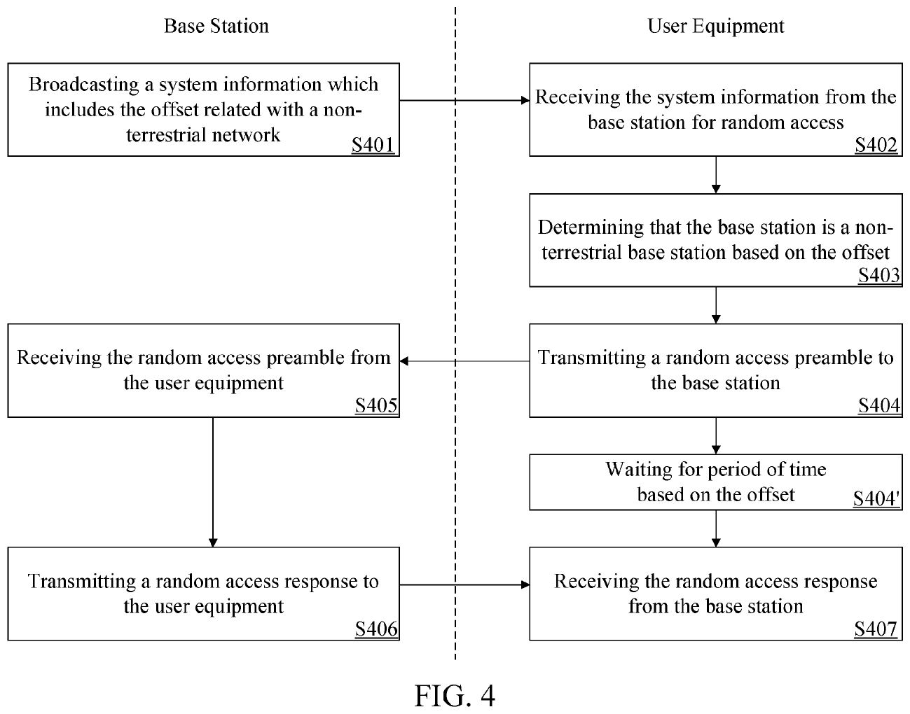

Some embodiments of the present disclosure include a method, and flowchart diagrams thereof are shown in FIG. 4. The method of some embodiments is for use in a network system (e.g., the network system of the aforesaid embodiments), and the network system includes a user equipment and a base station (e.g., the user equipment and the base station of the aforesaid embodiments). Detailed operations of the method are as follows.

Operation S401 is executed to broadcast, by the base station, a system information which includes an offset related with a non-terrestrial network. Operation S402 is executed to receive, by the user equipment, the system information from the base station for random access. Operation S403 is executed to determine, by the user equipment, that the base station is a non-terrestrial base station based on the offset of the system information.

Operation S404 is executed to transmit, by the user equipment, a random access preamble to the base station. It should be noted that, after the random access preamble is transmitted, operation S404′ is executed, by the user equipment, to wait fir a period of time based on the offset to receive a response from the base station. As for the base station, operation S405 is executed to receive, by the base station, the random access preamble from the user equipment. Operation S406 is executed to transmit, by the base station, a random access response to the user equipment. After waiting the period of time based on the offset, operation S407 is executed to receive, by the user equipment, the random access response.

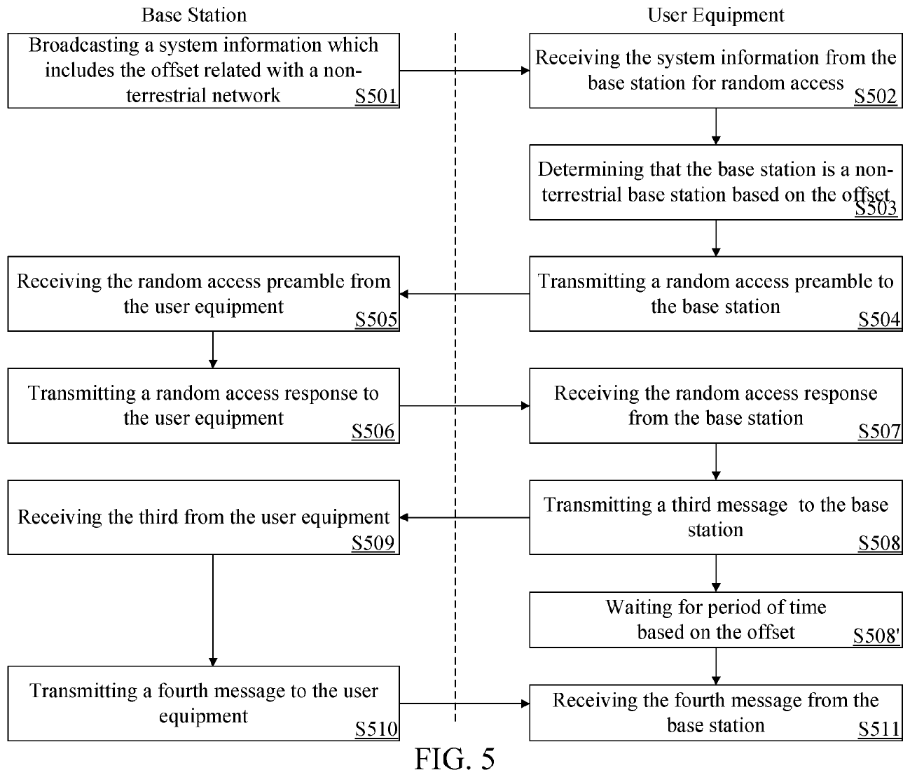

Some embodiments of the present disclosure include a method, and flowchart diagrams thereof are shown in FIG. 5. The method of some embodiments is for use in a network system (e.g., the network system of the aforesaid embodiments), and the network system includes a user equipment and a base station (e.g., the user equipment and the base station of the aforesaid embodiments). Detailed operations of the method are as follows.

Operation S501 is executed broadcast, by the base station, a system information which includes an offset related with a non-terrestrial network. Operation S502 is executed to receive, by the user equipment, the system information from the base station for random access. Operation S503 is executed to determine, by the user equipment, that the base station is a non-terrestrial base station based on the offset of the system information. Operation S504 is executed to transmit, by the user equipment, a random access preamble to the base station. Operation S505 is executed to receive, by the base station, the random access preamble from the user equipment.

Operation S506 is executed to transmit, by the base station, a random access response to the user equipment. Operation S507 is executed to receive, by the user equipment, the random access response. Operation S508 is executed to transmit, by the user equipment, a third message (e.g., a scheduled uplink transmission message as a third message in the random access procedure) to the base station. It should be noted that, after the third message is transmitted, operation S508′ is executed, by the user equipment, to wait for a period of time based on the offset to receive a response from the base station. As for the base station, operation S509 is executed to receive, by the base station, the third message from the user equipment. Operation S510 is executed to transmit, by the base station, a fourth message (e.g., a contention resolution response as fourth message in the random access procedure) to the user equipment. After waiting the period of time based on the offset, operation S511 is executed to receive, by the user equipment, the fourth message.

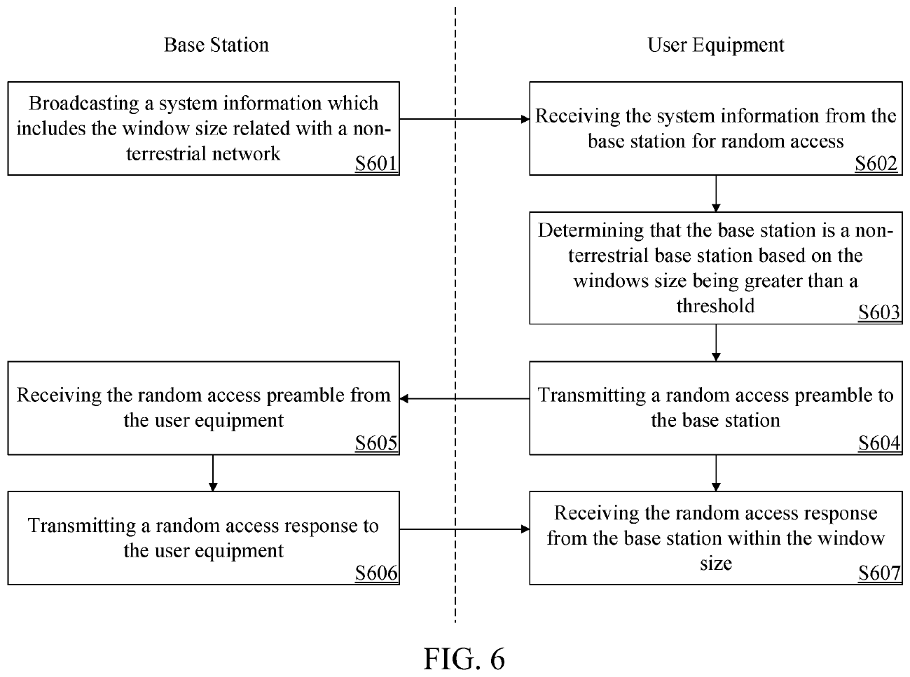

Some embodiments of the present disclosure include a method, and flowchart diagrams thereof are shown in FIG. 6. The method of some embodiments is for use in a network system (e.g., the network system of the aforesaid embodiments), and the network system includes a user equipment and a base station (e.g., the user equipment and the base station of the aforesaid embodiments). Detailed operations of the method are as follows.

Operation S601 is executed to broadcast, by the base station, a system information which includes a window size related with a non-terrestrial network. The window size is configured for the user equipment to receive random access response and is greater than a threshold. Operation S602 is executed to receive, by the user equipment, the system information from the base station for random access. Operation S603 is executed to determine, by the user equipment, that the base station is a non-terrestrial base station based on the window size being greater than the threshold.

Operation S604 is executed to transmit, by the user equipment, a random access preamble to the base station. Operation S605 is executed to receive, by the base station, the random access preamble from the user equipment. Operation S606 is executed to transmit, by the base station, a random access response to the user equipment. Operation S607 is executed to receive, by the user equipment, the random access response within the window size.

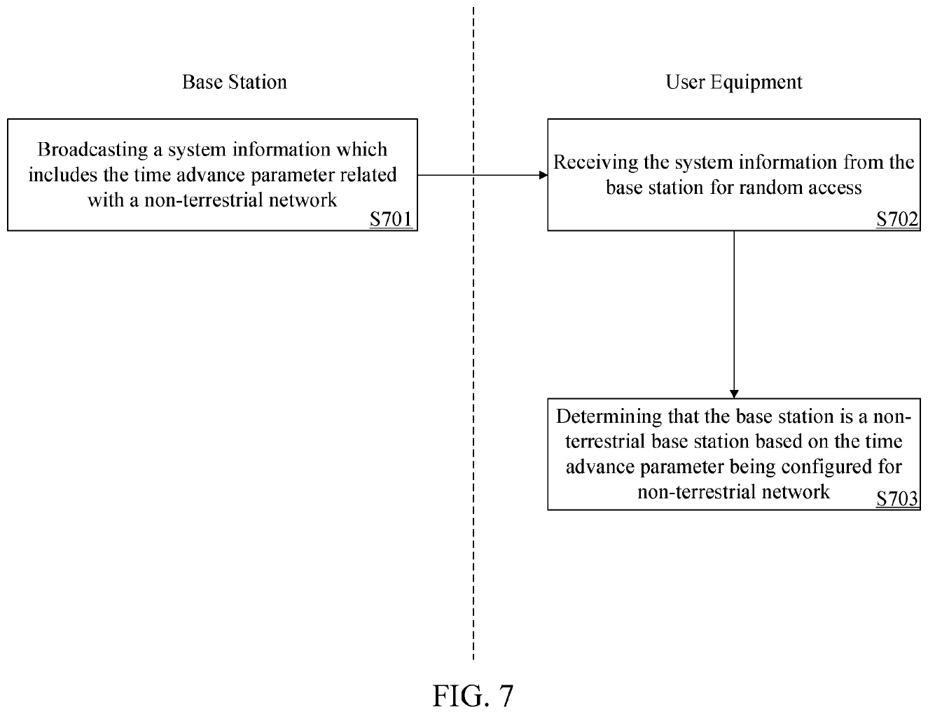

Some embodiments of the present disclosure include a method, and flowchart diagrams thereof are shown in FIG. 7. The method of some embodiments is for use in a network system (e.g., the network system of the aforesaid embodiments), and the network system includes a user equipment and a base station (e.g., the user equipment and the base station of the aforesaid embodiments). Detailed operations of the method are as follows.

Operation S701 is executed to broadcast, by the base station, a system information which includes a time advance parameter related with a non-terrestrial network. The time advance parameter is configured for the non-terrestrial network. Operation S702 is executed to receive, by the user equipment, the system information from the base station for random access. Operation S703 is executed to determine, by the user equipment, that the base station is a non-terrestrial base station based on the time advance parameter of the system information being configured for a non-terrestrial network.

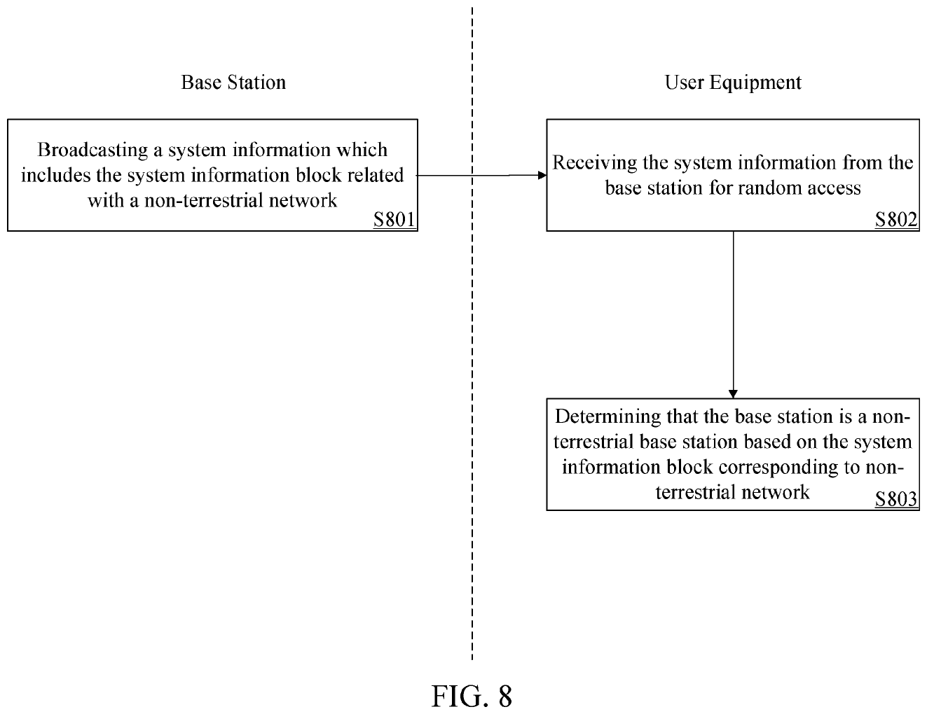

Some embodiments of the present disclosure include a method, and flowchart diagrams thereof are shown in FIG. 8. The method of some embodiments is for use in a network system (e.g., the network system of the aforesaid embodiments), and the network system includes a user equipment and a base station (e.g., the user equipment and the base station of the aforesaid embodiments). Detailed operations of the method are as follows.

Operation S801 is executed to broadcast, by the base station, a system information which includes a system information block corresponding to a non-terrestrial network. Operation S802 is executed to receive, by the user equipment, the system information from the base station. Operation S803 is executed to determine, by the user equipment, that the base station is a non-terrestrial base station based on the system information block corresponding to a non-terrestrial network.

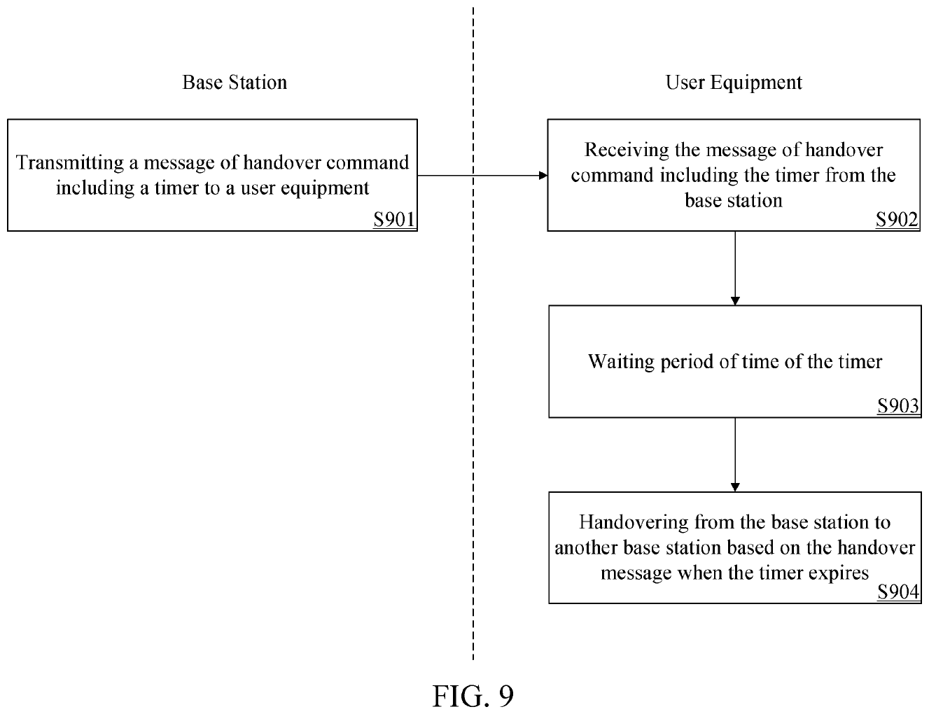

Some embodiments of the present disclosure include a method, and flowchart diagrams thereof are shown in FIG. 9. The method of some embodiments is for use in a network system (e.g., the network system of the aforesaid embodiments), and the network system includes a user equipment and a base station (e.g., the user equipment and the base station of the aforesaid embodiments) which are under radio resource connection connected status. Detailed operations of the method are as follows.

Operation S901 is executed to transmit, by the base station, a message of handover command including a timer to the user equipment. Operation S902 is executed to receive, by the user equipment, the message of handover command including the timer. Operation S903 is executed to wait, by the user equipment, a period of time of the timer. Operation S904 is executed to handover, by the user equipment, from the base station to another base station based on the handover message when the timer expires.

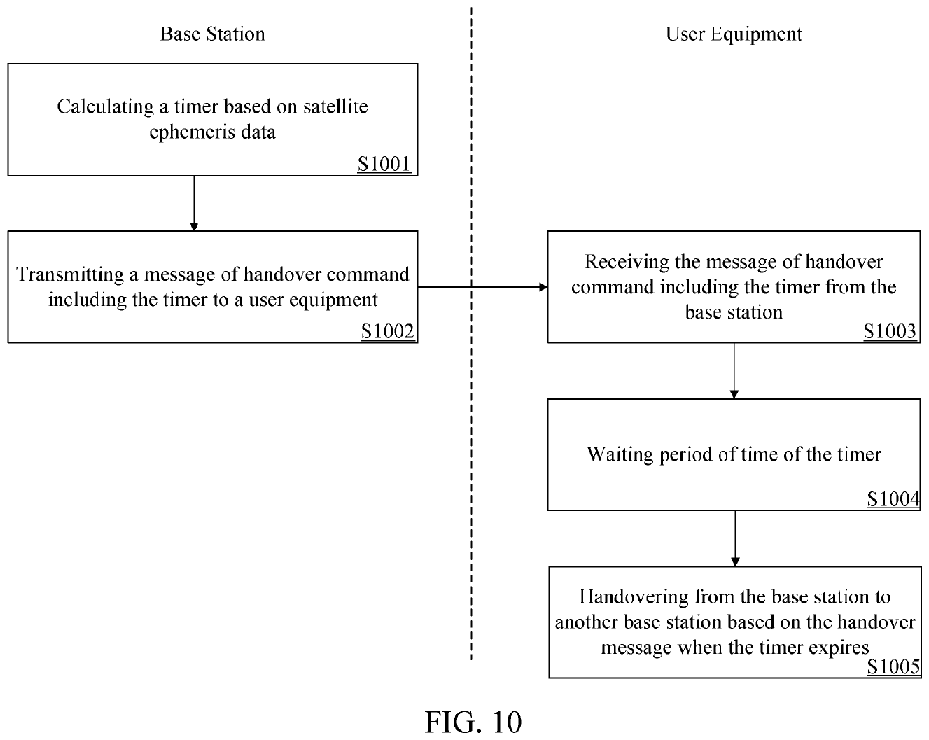

Some embodiments of the present disclosure include a method, and flowchart diagrams thereof are shown in FIG. 10. The method of some embodiments is for use in a network system (e.g., the network system of the aforesaid embodiments), and the network system includes a user equipment and a base station (e.g., the user equipment and the base station of the aforesaid embodiments) which are under radio resource connection connected status. Detailed operations of the method are as follows.

Operation S1001 is executed to calculate, by the base station, a timer based on satellite ephemeris data while the base station is a non-terrestrial base station disposed on satellite. Operation S1002 is executed to transmit, by the base station, a message of handover command including the timer to the user equipment. Operation S1003 is executed to receive, by the user equipment, the message of handover command including the timer. Operation S1004 is executed to wait, by the user equipment, a period of time of the timer. Operation S1005 is executed to handover, by the user equipment, from the base station to another base station, which is a non-terrestrial base station as well, based on the handover message when the timer expires.

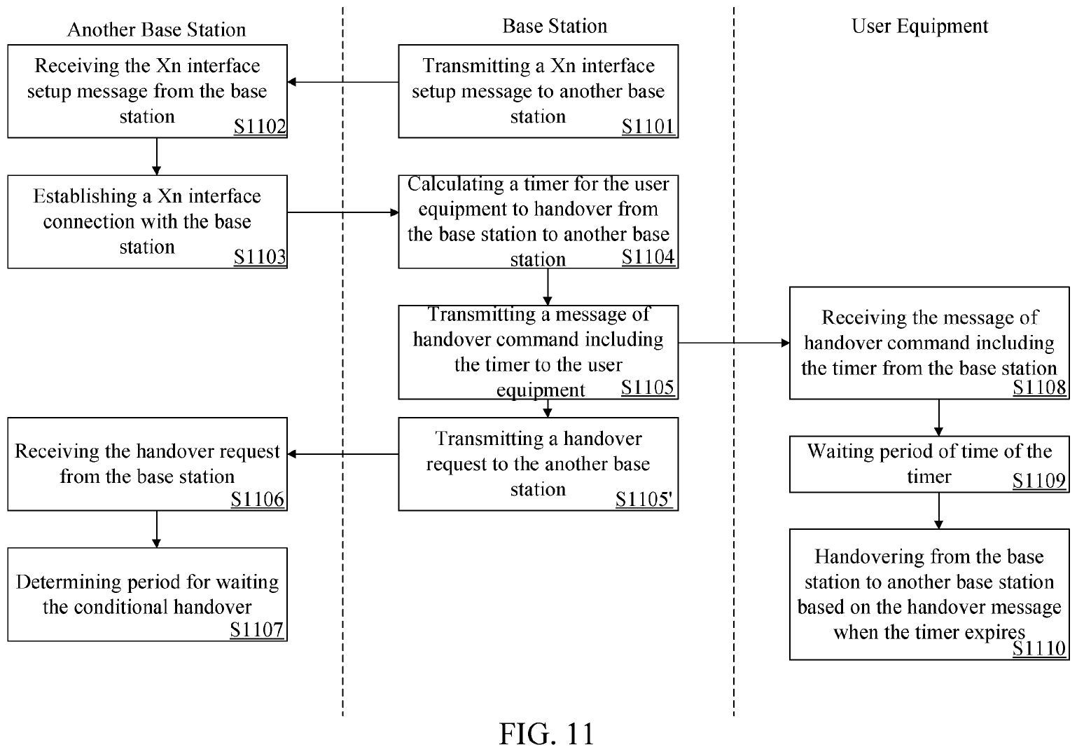

Some embodiments of the present disclosure include a method, and flowchart diagrams thereof are shown in FIG. 11. The method of some embodiments is for use in a network system (e.g., the network system of the aforesaid embodiments), and the network system includes a user equipment and a base station (e.g., the user equipment and the base station of the aforesaid embodiments) which are under radio resource connection connected status. Detailed operations of the method are as follows.

Operation S1101 is executed to transmit, by the base station, an Xn interface setup message to another base station for establishing connection between the base stations. The Xn interface setup message includes a cell type of the base station. In some embodiments, the cell type includes a geostationary type or a low earth orbit type. Operation S1102 is executed to receive, by the another base station, the Xn interface setup message from the base station. Operation S1103 is executed to establish, by the another base station, an Xn interface connection with the base station.

Operation 51104 is executed to calculate, by the base station, a timer for the user equipment to handover from the base station to another base station. Operation S1105 is executed to transmit, by the base station, a message of handover command including the timer to the user equipment. Operation S1105′ is executed to transmit, by the base station, a handover request to the another base station. The handover request includes an indication for a later conditional handovering from the user equipment. In some embodiments, the operation S1105′ may be executed before S1105 or executed with S1105. As for the another base station, operation S1106 is executed to receive, by the another base station, the handover request from the base station. Operation S1107 is executed to determine, by the another base station, a period for waiting the conditional handover. If the period is elapsed but the user equipment does not perform the handover, the base station releases resources related to the information of the user equipment.

As for user equipment, operation S1108 is executed to receive, by the user equipment, the message of handover command including the timer. Operation S1109 is executed to wait, by the user equipment, a period of time of the timer. Operation S1110 is executed to handover, by the user equipment, from the base station to another base station based on the handover message when the timer expires.

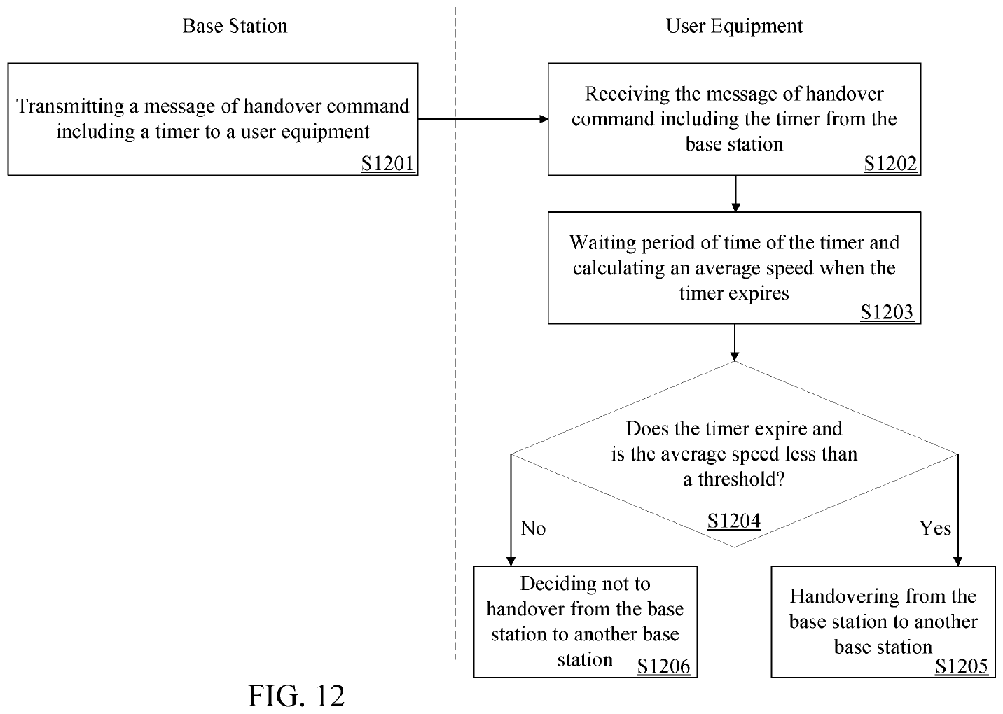

Some embodiments of the present disclosure include a method, and flowchart diagrams thereof are shown in FIG. 12. The method of some embodiments is for use in a network system (e.g., the network system of the aforesaid embodiments), and the network system includes a user equipment and a base station (e.g., the user equipment and the base station of the aforesaid embodiments) which are under radio resource connection connected status. Detailed operations of the method are as follows.

Operation S1201 is executed to transmit, by the base station, a message of handover command including a timer to the user equipment. Operation S1202 is executed to receive, by the user equipment, the message of handover command including the timer. Operation S1203 is executed to wait, by the user equipment, a period time of the timer and to calculate an average speed of the user equipment when the timer expires. Operation S1204 is executed to determine, by the user equipment, whether the timer expires and the average speed is less than a threshold. If yes, operation S1205 is executed to handover, by the user equipment, from the base station to another base station. If no, operation S1206 is executed to determine, by the user equipment, not to handover from the base station to another base station.

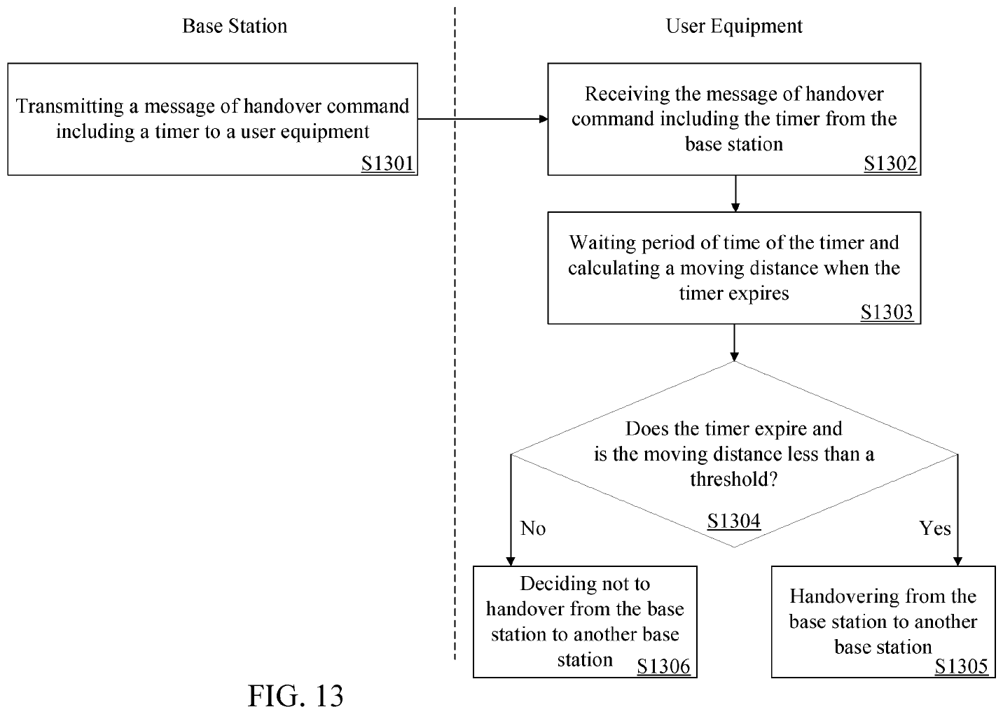

Some embodiments of the present disclosure include a method, and flowchart diagrams thereof are shown in FIG. 13. The method of some embodiments is for use in a network system (e.g., the network system of the aforesaid embodiments), and the network system includes a user equipment and a base station (e.g., the user equipment and the base station of the aforesaid embodiments) which are under radio resource connection connected status. Detailed operations of the method are as follows.

Operation S1301 is executed to transmit, by the base station, a message of handover command including a timer to the user equipment. Operation S1302 is executed to receive, by the user equipment, the message of handover command including the timer. Operation S1303 is executed to wait, by the user equipment, a period of time of the timer and to calculate a moving distance of the user equipment when the timer expires. Operation S1304 is executed to determine, by the user equipment, whether the timer expires and the moving distance is less than a threshold. If yes, operation S1305 is executed to handover, by the user equipment, from the base station to another base station. If no, operation S1306 is executed to determine, by the user equipment, not to handover from the base station to another base station.

It should be noted that, based on the disclosures above, those skilled in the art should understand that the term “handovering” may be performing a handover procedure, and “handovering from the base station to another base station” may be performing a handover procedure from the base station to another base station.

The method of the present disclosure can be implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While the present disclosure has been described with specific embodiments thereof, it is evident that many alternatives, modifications, and variations will be apparent to those ski lied in the art. For example, various components of the embodiments may be interchanged, added, or substituted in the other embodiments. Also, all of the elements shown in each figure are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

1. A method of a user equipment comprising:
receiving, by the user equipment, a system information from a base station for random access, wherein the system information comprises a parameter; and
determining, by the user equipment, whether the base station is a non-terrestrial base station or a terrestrial base station based on the parameter included in the system information.

2. The method of claim 1, wherein the parameter comprises an offset and the operation of determining further comprises determining, by the user equipment, that the base station is the non-terrestrial base station based on the offset, wherein the user equipment starts to detect a random access response from the base station after waiting for a period of time based on the offset, wherein the period starts after a random access preamble is transmitted to the base station.

3. The method of claim 1, wherein the parameter comprises an offset and the operation of determining further comprises determining, by the user equipment, that the base station is the non-terrestrial base station based on the offset, wherein the user equipment starts to receive a response from the base station after waiting for a period of time based on the offset, wherein the period starts after a third message of random access procedure is transmitted to the base station.

4. The method of claim 1, wherein the parameter comprises a window size for receiving a random access response and the operation of determining further comprises determining, by the user equipment, that the base station is the non-terrestrial base station when the window size is greater than a threshold.

5. The method of claim 1, wherein the parameter comprises a time advance parameter and the operation of determining further comprises determining, by the user equipment, that the base station is the non-terrestrial base station when the time advance parameter is configured for a non-terrestrial network.

6. The method of claim 1, wherein the system information comprises a system information block which comprises the parameter corresponding to a non-terrestrial network.

7. A method of a base station comprising:
broadcasting, by the base station, a system information which comprises the parameter to the user equipment, wherein the parameter corresponds to a non-terrestrial base station.

8. The method of claim 7, wherein the parameter comprises an offset for the user equipment to determine that the base station is the non-terrestrial base station, wherein the user equipment starts to detect a random access response from the base station after waiting for a period of time based on the offset, wherein the period starts after a random access preamble is transmitted to the base station.

9. The method of claim 7, wherein the parameter comprises an offset for the user equipment to determine that the base station is the non-terrestrial base station, wherein the user equipment starts to receive a response from the base station after waiting a period of time based on the offset, wherein the period starts after a third message of a random access procedure is transmitted to the base station.

10. The method of claim 7, wherein the parameter comprises a window size, which is greater than a threshold, for transmitting a random access response so that the user equipment determines that the base station is the non-terrestrial base station based on that the window size is greater than the threshold.

11. The method of claim 7, wherein the parameter comprises a time advance parameter which is configured for a non-terrestrial network so that the user equipment determines that the base station is the non-terrestrial base station based on that the time advance parameter is used for the non-terrestrial network.

12. The method of claim 7, wherein the system information comprises a system information block which comprises the parameter corresponding to a non-terrestrial network.

13. A method of a user equipment comprising:
receiving, by the user equipment, a message of handover command including a timer from a base station; and
handovering, by the user equipment, from the base station to another base station based on the message when the timer expires.

14. The method of claim 13, wherein the timer starts when the user equipment receives the message including the timer.

15. The method of claim 13, wherein the operation of handovering is performed when an average speed of the user equipment is less than a threshold before the timer expires.

16. The method of claim 13, wherein the operation of handovering is performed when a moving distance of the user equipment is less than a threshold before the timer expires.

17. A method for a base station comprising:
transmitting, by the base station, a message of handover command including a timer to a user equipment so that the user equipment can handover from the base station to another base station based on the handover message when the timer expires.

18. The method of claim 17, further comprising calculating, by the base station, the timer based on satellite ephemeris data.

19. The method of claim 17, further comprising transmitting, by the base station, an Xn interface setup message to the another base station, wherein the Xn interface setup message comprises a cell type of the base station.

20. The method of claim 19, wherein the cell type comprises a geostationary earth orbit type or a low earth orbit type.

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)
